(19) United States
(12) Patent Application Publication
(10) Pub. No.: US 2024/0273780 A1
(43) Pub. Date: Aug. 15, 2024

(54) Overlaying 2D images

(71) Applicant: BRIKL B.V., Lubbeek (BE)

(72) Inventors: Sotorn SAENGTHONGSAKULLERT, Bangkok (TH); Maarten Emiel L. BOONE, Lubbeek (BE)

(73) Assignee: BRIKL B.V., Lubbeek (BE)

(21) Appl. No.: 18/168,623

(22) Filed: Feb. 14, 2023

(51) Int. Cl. G06T 11/00; G06T 7/13

(52) U.S. Cl. CPC G06T 11/001; G06T 7/13; G06T 2207/10024; G06T 2210/16; G06T 2210/62

(57) ABSTRACT

A computer-implemented method for overlaying 2D images, comprising: providing a first 2D image and a second 2D image, wherein the first 2D image is a digital representation of a first object having a 3D surface, and wherein the second 2D image overlaps the first object in the first 2D image at a particular location; generating a greyscale 2D image of the first 2D image; generating a displacement map of the greyscale 2D image; adjusting the second 2D image, including: trimming part of the second 2D image overlapping an upper part of the first object, displacing pixels of the second 2D image overlapping the first object based on the displacement map, and multiplying the displaced pixels of the second 2D image with pixels of the greyscale 2D image; and providing the adjusted second 2D image at the particular location on the first 2D image.

### FIELD OF THE INVENTION

The present disclosure relates to a method of overlaying 2D images, specifically for overlaying an image on a clothing apparel and/or accessories.

### BACKGROUND ART

Custom and promotional businesses spend a huge amount of time customizing products, such as clothing apparel and accessories. Such businesses have known suppliers of customized products and are looking to customize with additional images. Conventional techniques for designing and producing the products suffer from several disadvantages. For example, producing a sample of a product to check how the final product looks like can be expensive, since it can require multiple rounds of sample production with incremental changes.

Online platforms are being used to customize the products by providing tools to embellish and visualize these products. Such platforms allow the businesses to add images to a digital representation or image of a physical product. The way this is typically done is by overlaying 2D images which is known in the field of image rendering.

It is often preferred that digital representation of the physical products show a natural look of the product. This is particularly common for clothing apparel where they have an uneven or unflattened surface, such as the 3D surface of rippled fabric. Furthermore, many physical products have a particular texture that would be important to show in their digital representation. Therefore, when overlaying an image onto the digital representation of a product, these textures and/or changes in the surface of the product are not effectively shown. Thus, the custom and promotional businesses have difficulty visualizing and designing custom and promotional products.

It remains a problem to provide an improved method and apparatus for providing more visually realistic digital representations of custom and promotional products. Therefore, what is needed is a method and apparatus that allows for non-traditional overlaying of 2D images.

### SUMMARY

According to an aspect of the present disclosure, a computer-implemented method is provided for overlaying 2D images, comprising:
providing a first 2D image and a second 2D image, wherein the first 2D image includes or is a digital representation of a first object having a 3D surface, and wherein the second 2D image, preferably one or more objects in the second 2D image, overlaps the first object in the first 2D image at a particular location;
generating greyscale 2D image of the first 2D image;
generating a displacement map of the greyscale 2D image;
adjusting the second 2D image based on the greyscale 2D image and the displacement map, including:
   displacing pixels of the second 2D image overlapping the first object based on the displacement map, and
   multiplying the displaced pixels of the second 2D image with pixels of the greyscale 2D image;

− providing the adjusted second 2D image at the particular location on the originally provided first 2D image.

It is an advantage to perform the combination of displacing pixels of the at least part of the second 2D image and multiplying said pixels with pixels of the greyscale 2D image. This provides displacement or embossing effect and, at the same time, preserves the original colors of the overlayed image (this is described in more detail below). Thus, this makes the overlaying of the 2D images more natural over the surface base image (i.e., the first 2D image). Furthermore, it provides the user improved information on the resulting product to be produced. This reduces the costs resulting from iterative production of a mock sample and redesigning the product, and ensures a more efficient process of obtaining a custom and promotional product.

According to embodiments, the step of providing the first 2D image includes: detecting edges of the first object in the first 2D image, the first object being in the foreground of the first 2D image, and the first object and the background of the first 2D image having contrasting colors, preferably at least the edges of the first object and the background of the first 2D image having contrasting colors.

It is an advantage of detecting edges of the first object while providing the first 2D image to ensure that the second 2D image, preferably the one or more objects in the second 2D image, is overlapping the first object. Therefore, a user providing instructions to overlay the first and second 2D images can be notified that the second 2D image, preferably the one or more objects in the second 2D image, is not overlapping the desired first object and the resulting overlayed images will only be the first 2D image. Thus, the method provides a more effective and reliable means of overlaying images.

According to embodiments, the method further comprises generating a final image based on the placement of the second 2D image at the particular location on the first 2D image; and displaying the final image via a graphical user interface (GUI), wherein the final image displays a realistic view of the second 2D image on the 3D surface without having to physically print the second 2D image on the first object.

By displaying on the GUI a realistic view of the second 2D image on the 3D surface without having to physically print the second 2D image on the first object, the present inventors have found that an improvement over conventional custom and/or promotional product design and production technology in several ways relative to conventional custom and/or promotional product design and on-site production. Particularly, the inventors have found that by displaying a realistic view of an image on the 3D surface of a digital representation of a product, the present disclosure minimizes wasted material for producing the object, and, thereby, reduces the overall costs associated with physically printing an image on the physical object to provide a realistic view of the image on the 3D surface of the physical object.

According to embodiments, the step of generating the greyscale 2D image includes generating a trimmed image by replacing pixels in the first image not part of the first object with transparent pixels.

In many instances, the custom and promotional products when used for customization and/or promotion in a 2D image are shown in the foreground of the first 2D image, and have a background that is detectable from the foreground. Typically, the background is in a color/pattern different from the color/pattern of the product, wherein at least the pixels of the background neighboring the pixels of the foreground (i.e., product) have contrasting/differing colors.

Alternatively, the pixels not part of the first object or the background pixels of the first 2D image are removed.

It is an advantage of removing/replacing the pixels of the background, in that the process of overlaying the 2D images is made even more efficient. Here, at least the steps of generating a greyscale 2D image and a displacement map thereof are performed only on the first object in the first 2D image. Therefore, by reducing the number of pixels processed, the resulting process is more efficient.

According to embodiments, wherein the step of adjusting the second 2D image further includes: trimming a part of the second 2D image not overlapping the first object in the first 2D image by replacing pixels of the second 2D image, preferably pixels of the one or more objects in the second 2D image, not overlapping the first object in the first 2D image with transparent pixels.

Alternatively, said pixels of the second 2D image, preferably said pixels of the one or more objects in the second 2D image, not overlapping the first object are removed. In other words, part of the second 2D image, preferably part of the one or more objects in the second 2D image, not overlapping the first object is trimmed or cut.

It is an advantage of removing/replacing the pixels of the second 2D image, preferably the pixels of the one or more objects in the second 2D image, not overlapping the first object, in that the process of overlaying the 2D images is made even more efficient. Here, the number of pixels in the second 2D image are reduced, and accordingly, the size of the second 2D image is reduced. Furthermore, the step of adjusting all the remaining pixels of the second 2D image is performed more efficiently.

According to embodiments, the step of generating the greyscale 2D image includes generating a trimmed image by:
detecting edges of an upper part of the first object, the upper part being on top of a lower part of the first object in the first 2D image, and the upper and lower parts having contrasting colors, preferably the edges of the upper part have contrasting colors with the lower part; and
replacing pixels of the upper part of the first object with transparent pixels,
   wherein the step of adjusting the second 2D image includes trimming part of the second 2D image overlapping the upper part of the first object.

For example, the pixels of the upper part of the first object are removed. In other words, the upper part of the first object is trimmed or cut.

It is an advantage of detecting the edges of the upper part of the first object and removing/replacing the pixels of the upper part, in that the resulting overlay shows the at least part of the second 2D image, particularly a part overlapping with the upper part of the first object, when overlayed with the first 2D image, as being underneath the upper part of the first object and on the lower part of the first object. Therefore, the second 2D image, preferably the one or more objects in the second 2D image, overlapping the upper part of the first object would be overlayed in between the upper and lower parts of the first object in the first 2D image. Thus, this makes the overlaying of the 2D images more natural over the surface base image (i.e., the first 2D image) and underneath at least a part is on top of the main part of the surface base image. Furthermore, by considering the different parts of the first object, the user is provided improved information on the resulting product to be produced. This reduces the costs resulting from iterative production of a mock sample and redesigning the product, and ensures a more efficient process of obtaining a custom and promotional product.

It is a further advantage that the process of overlaying the 2D images is made even more efficient. Here, at least the steps of generating a greyscale 2D image and a displacement map thereof are performed on less pixels of the first object in the first 2D image, particularly not on pixels of the upper part of the first object. Therefore, by reducing the number of pixels processed, the resulting process is more efficient.

Alternatively, the first 2D image includes an upper layer including the upper part of the first object and a lower layer including the lower part of the first object, wherein the step of generating the greyscale 2D image includes generating the trimmed image by replacing pixels of the upper layer or removing the upper layer.

It is thus an advantage that the second 2D image, preferably the one or more objects in the second 2D image, is overlayed on the lower layer in between the upper layer and the lower layer.

Preferably, the step of generating the greyscale 2D image includes generating the trimmed image by:
detecting pixels of the upper part being overlapped by the second 2D image, preferably the one or more objects in the second 2D image; and
replacing the overlapped pixels of the upper part of the first object with transparent pixels.

It is an advantage that the process of overlaying the 2D images is made even more efficient. Here, at least the steps of generating a greyscale 2D image and a displacement map thereof are performed on less pixels of the first object in the first 2D image, particularly not on overlapped pixels of the upper part of the first object. Furthermore, the number of pixels replaced by transparent pixels is reduced to only the overlapped pixels. Therefore, the resulting process is more efficient.

According to embodiments, the step of trimming the at least part of the second 2D image includes:
detecting pixels of the second 2D image overlapping the upper part of the first 2D image; and
replacing the overlapped pixels of the second 2D image with transparent pixels.

Therefore, when detecting the second 2D image, the pixels of the second 2D image, preferably the pixels of the one or more objects in the second 2D image overlapping the upper part of the first object are more effectively trimmed.

This results in the second 2D image, preferably the one or more objects in the second 2D image being overlayed in between the upper and lower parts of the first object.

For example, the pixels of the part of the second 2D image overlapping with the upper part of the first object in the first 2D image are removed. In other words, part of the second 2D image overlapping with the upper part of the first object in the first 2D image is trimmed or cut.

It is an advantage of removing/replacing the pixels of a part of the second 2D image overlapping with the upper part of the first object in the first 2D image, in that the process of overlaying the 2D images is made even more efficient. Here, the number of pixels in the second 2D image are further reduced, and accordingly, the size of the second 2D image is reduced.

Furthermore, the step of adjusting all the remaining pixels of the second 2D image is performed more efficiently.

According to embodiments, the second 2D image includes or is an object, such as a digitally created/generated object.

Preferably, the second 2D image includes one or more layers, each layer including an object in the foreground of the layer and transparent pixels in the background of the layer.

Advantageously, the method can overlay a plurality of objects simultaneously. This ensures more efficient processing, particularly the adjusting of the at least part of the second 2D image.

According to embodiments, the method further comprises upon receiving the instructions:
detecting edges of one or more objects of the second 2D image; and
replacing pixels in the second 2D image not part of the one or more objects with transparent pixels.

Alternatively, the pixels of the background in the second 2D image are removed. In other words, part of the second 2D image other than the one or more objects is trimmed or cut.

It is an advantage of detecting the edges of one or more objects in the second 2D image and removing/replacing the pixels of the background (i.e., not part of the one or more objects), in that the number of pixels in the second 2D image that are processed/adjusted are reduced. Thereby, more efficient processing, particularly the adjusting of the at least part of the second 2D image, can be performed.

In further alternative examples, the second 2D image includes a foreground layer having the one or more objects and a background layer, wherein pixels in the background layer are removed or the background layer is removed.

According to embodiments, the method further comprises receiving instructions from a user, the instructions including overlaying the second 2D image onto the particular location of the provided first 2D image.

According to embodiments, the method further comprises increasing dimensions of the second 2D image to be equal to dimensions of the first 2D image by adding transparent pixels.

Advantageously, the method ensures that the particular location on the first 2D image onto which the second 2D image is overlayed is maintained. Furthermore, by having images with equal sizes the overlaying can be performed in a more efficient way, such as by performing the steps of displacing and multiplying of the pixels in groups, wherein for each group of pixels the steps of displacing and multiplying are performed on a processor from a plurality of processors.

In a second aspect, which may be combined with the other aspects and embodiments described herein, the invention provides a non-transitory computer readable medium embodying computer executable instructions which when executed by a computer cause the computer to facilitate the computer-implemented method according to the invention.

In a third aspect, which may be combined with the other aspects and embodiments described herein, the invention provides an apparatus comprising a memory embodying computer executable instructions and at least one processor, coupled to the memory, and operative by the computer executable instructions to facilitate the computer-implemented method according to the invention.

### BRIEF DESCRIPTION OF THE DRAWINGS

The present invention will be discussed in more detail below, with reference to the attached drawings.

FIG. 1 illustrates examples of a method according to the invention;

FIG. 2 illustrates an overview of examples of a method according to the invention

FIGS. 3-7 illustrate examples of a method according to the invention;

FIG. 8 illustrates examples of an apparatus according to the invention.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

The terms “overlapping” images are to be interpreted as placing images such that they have an area in common. Therefore, overlapped images refer to images with an area in common.

The superimposition of overlapped images (“superimposed images” hereinafter) over a single image (“reference image” hereinafter) is termed “overlay”.

The terms “base image” and “reference image” are used herein interchangeably are to be interpreted as a first (2D) image onto which a second (2D) image is overlayed or superimposed. It will be understood that the first image includes or is a digital representation of a first object.

The term “overlay image” is to be interpreted as the second (2D) image which is overlayed or superimposed onto the first (2D) image.

Hereinafter, images displayed in overlay mode are termed “overlayed images”.

The term “transparent pixel” is to be interpreted as an invisible pixel, also referred to as a zero alpha channel pixel. Many color models can be used to specify colors numerically for an image. An additional component can be added to the color models, called alpha, which is not a color as such and is used to represent transparency. A color with zero alpha is transparent and therefore invisible, whereas a color with maximal alpha value is fully opaque.

The term “contrasting colors” is to be interpreted as colors when placed next to each other create a contrast for those two colors. Examples include but are not limited to complementary or opposite colors. In other examples, the color intensity is used to create contrasting colors.

In examples, the first 2D image includes a digital representation of a first object having a 3D surface, wherein the first object is any one of: clothing apparel, garments, furniture, etc., preferably clothing apparel. In preferred embodiments, the first 2D image is a digital image taken by a camera or a camera-containing device (e.g., smartphone).

In examples, the second 2D image includes one or more objects, wherein the one or more objects in the second 2D image is/are any one or combination of: a symbol, a motto, a logo, a drawing, a picture, etc., preferably a logo.

Embodiments of the method according to the invention will be described with reference to FIG. 2. FIG. 2 illustrates a method of overlaying 2D images, comprising step 202 of providing the first 2D image and the second 2D image; step 204 of generating a greyscale 2D image of the first 2D image; step 206 of generating a displacement map of the greyscale 2D image; step 208 of adjusting the second 2D image; step 210 of providing the adjusted second 2D image at the particular location on the originally provided first 2D image; step 211 of generating a final image; and step 212 of displaying the final image. Step 201 of receiving instruction from a user is optional and will be described in more detail below.

The step 202 of providing the first and second 2D images may include extracting said images from an input image. The input image may already include the second 2D image displayed on top of the first 2D image, particularly at a predetermined particular location. The predetermined particular location may be determined by a user or as a default location. The step of extracting may be performed by identifying the bottom layer(s) in the input image as the base image (i.e., the first 2D image) and identifying the remaining layer(s) on top of the bottom layer(s) as the overlay image (i.e., second 2D image). The bottom layer(s) may be an upper layer and a lower layer in the first image or a single layer in the first image.

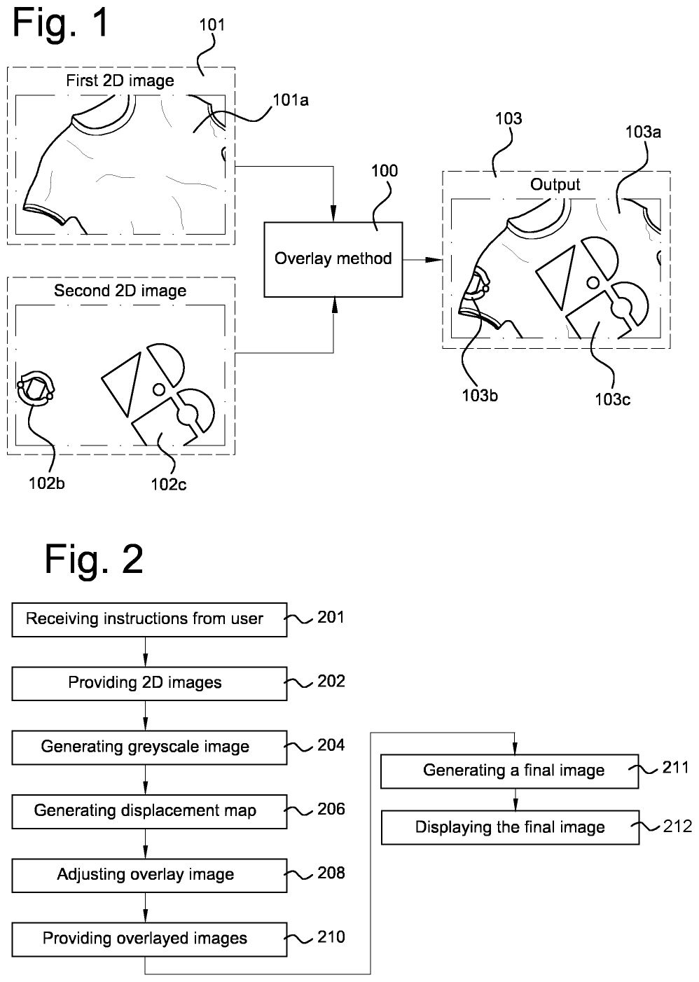

The second 2D image in the input image may include one or more layers, wherein each layer includes an object. The dimensions of the layers and of the second 2D image may be equal to the dimensions of the first 2D image. One example is described with reference to FIG. 1 below. In another example, the dimensions of the one or more layers are increased to be equal to the dimensions of the first 2D image by adding transparent pixels, thereby increasing the dimensions of the second 2D image to be equal to the dimensions of the first 2D image.

The dimensions of each layer in the second 2D image may be equal to the dimensions of the first 2D image either before or after the step of extraction. Preferably, the dimensions of each layer in the second 2D image may be increased to be equal to the dimensions of the first 2D image either before or after the step of extraction. The step of increasing dimensions of the second 2D image to be equal to dimensions of the first 2D image by adding transparent pixels may be performed in any one of the steps 202 and 206.

The second 2D image may include a single layer including a plurality of objects, such as by merging a plurality of layers into the single layer. The merging of the plurality of layers may be performed either before or after the step of extraction.

In examples, where the dimensions of the second 2D image are equal to the dimensions of the first 2D image, when aligning the first and second 2D images (e.g., aligning the corners), the one or more objects in the second image may overlap the first object in the first 2D image at one or more particular locations. Preferably, the second 2D image includes one or more objects which overlap the first object in the first 2D image at the particular location.

The first 2D image may include a single layer with the first object and a background. Thus, the step 202 of providing the first 2D image may include the step of detecting edges of the first object in the first 2D image and/or the step replacing pixels not part of the first object with transparent pixels. Otherwise, at least one of these steps may be performed in the step of generating a grayscale image, as described below. These steps may be performed by applying edge detection algorithm and/or a filling algorithm and/or masking algorithm as described below.

The first 2D image may include a single layer with the first object in the foreground and no background (i.e., having pixels not part of the object being transparent). Thus, the step of edge detection and/or the step of replacing background pixels with transparent pixels may not be needed, but may still be performed in the step 202 to ensure that the object edges are correctly detected and/or all the background is transparent. Otherwise, at least one of these steps may be performed in the step of generating a grayscale image, as described below. These steps may be performed by applying edge detection algorithm and/or a filling algorithm and/or masking algorithm as described below.

The first 2D image may include a plurality of layers, wherein the top layer(s) include the first object and the bottom layer(s) include the background. Thus, the step 202 of providing the first 2D image may include the step of detecting edges of the first object in the top layer(s) of the first 2D image and/or the step replacing pixels not part of the first object in the top layer(s) with transparent pixels and/or the step of removing the bottom layer(s). Otherwise, at least one of these steps may be performed in the step of generating a grayscale image, as described below. These steps may be performed by applying edge detection algorithm and/or a filling algorithm and/or masking algorithm as described below.

The second 2D image may be provided including one or more layers, each layer including an object in the foreground of the layer and transparent pixels in the background of the layer. Alternatively, the second 2D image is provided as a single layer including one or more objects in the foreground of the layer and transparent pixels in the background of the layer. More alternatively, the second 2D image is provided including one or more objects in a single layer. The step 202 of providing the second 2D image may include detecting edges of the one or more objects and replacing pixels other than pixels of the one or more objects with transparent pixels. Thus, the one or more objects are considered to be in the foreground of the second 2D image and the transparent pixels in the background. The one or more objects may be detected by applying an edge detection algorithm and/or the pixels not part of the one or more objects (i.e., the background) are replaced with pixels by applying any filling or masking algorithm, as described below.

The step 210 of providing the overlayed images, i.e., the adjusted second 2D image at the particular location on the first 2D image, may be provided as a single 2D image, either having each of the first and second 2D images as a layer or having both as a single layer (e.g., merged). Alternatively, the output may be the two images (i.e., first and second 2D images) which are aligned such that the second 2D image is provided at the particular location on the first 2D image. Therefore, it will be understood that the one or more objects in the second 2D image, as described herein, are overlayed onto the first 2D image. Preferably, the overlayed images in the step 210 are provided such that the originally provided first 2D image is used, particularly the first 2D image provided in step 202. More preferably, the originally provided first 2D image (i.e., provided in step 202) is the first 2D image before any of the step of detecting edges and/or the step of replacing pixels has been performed. Therefore, it will be understood that the one or more objects in the second 2D image, as described herein, are overlayed onto the originally provided first 2D image.

The step 211 of generating a final image based on the placement of the second 2D image at the particular location on the first 2D image may be provided as an output of the method. The output of the method is a single 2D image. The step 212 of displaying the final image via a graphical user interface (GUI) may be displayed via the GUI 830 of the apparatus 800 described herein, The step 212 is performed to display a realistic view of the second 2D image on the 3D surface without having to physically print the second 2D image on the first object.

The method may comprise the step 201 of receiving instructions from the user. The user instructions include at least one of: selecting a first 2D image, selecting one or more overlay images (e.g., second 2D image or a plurality of 2D images as the overlay image), adjusting the dimensions of at least one of the one or more overlay images, providing a particular location for each of the one or more overlay images, and overlaying the one or more overlay images onto the first 2D image. Other instructions of the user will be understood by a person skilled in the art, such as how the overlay images are displayed, changing one or more of the first, second and plurality of 2D images, etc. Preferably, the method comprises executing the user instructions.

FIG. 1 illustrates example embodiments of a method according to the invention, which are not intended to limit the scope of the invention in any way. It relates to a method of overlaying 2D images, wherein the overlay method 100 comprises providing a first 2D image 101 and a second 2D image 102, and providing or displaying an output 103 including the overlayed images.

As can be seen in FIG. 1, the first object 101a is a clothing apparel, particularly a t-shirt, and the first 2D image 101 is a representation thereof. The second 2D image 102 includes two objects 102b, 102c, each being a logo. The background in the first 2D image 101 is a mono color, and the background of the second 2D image 102 is transparent.

The dimensions of the first 2D image 101 and the second 2D image 102 is the same. Therefore, when the first 2D image 101 and the second 2D image 102 are aligned the two objects 102b, 102c overlap the first object 101a.

The first 2D image 101 and the second 2D image 102 are provided as input to the overlay method 100, which processes the images and overlays them, thereby providing or displaying the overlayed images as output 103.

As will be understood, the first 2D image 101 and the second 2D image 102 are provided by the overlay method 100, wherein the second 2D image 102, particularly the second 102b and third 102c objects overlap the first object 101a in the first 2D image at a particular location.

The output 103 in this example is provided or displayed as a single 2D image including the first 2D image 101 having the first object 103a and the overlayed second 103b and third 103c objects thereon.

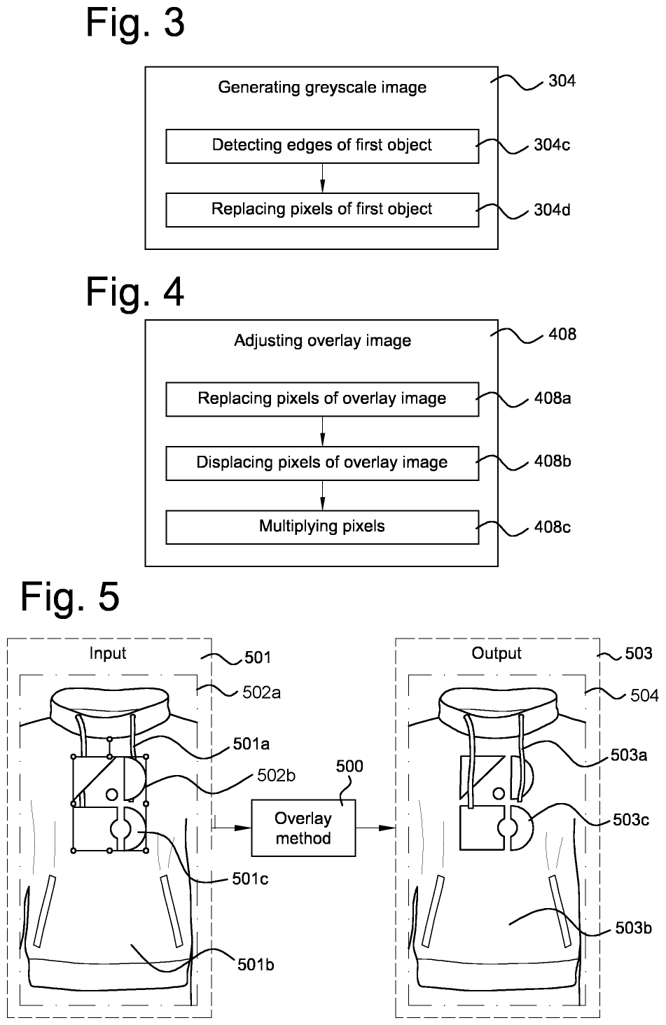

Embodiments of the method according to the invention will be described with reference to FIG. 3. FIG. 3 illustrates the step of generating 304 a greyscale 2D image which may correspond to the step 204.

The step 304 of generating a greyscale 2D image may include step 304d of generating a trimmed image by replacing pixels not part of the first object (i.e., in the of the background of the first object or first 2D image) with transparent pixels. Optionally, the step 304 of generating a greyscale 2D image comprises step 304c of detecting edges of the first object. These steps can be performed by a filling or masking algorithm, as described below. The step 304c may not be necessary in the case where the step 202 includes the step of detecting edges of the first object, as described herein. Preferably, the step 304d involves replacing pixels not part of the first object overlapping with the second 2D image, preferably with the one or more objects in the second 2D image, with transparent pixels.

The edge detection algorithm may be a Canny edge detector or Sobel edge detector. Other algorithms known in the art for edge detection of the detection of the first object may also be applied, such as a filling or masking algorithm described below.

The filling algorithm may be a flood fill or seed fill algorithm which determines and alters the area connected to a given node in a multi-dimensional array with some matching attribute (e.g., color intensity). This attribute can be adjusted to manage the detection of nearest neighbor pixels (e.g., same color, intensity, etc.), where pixels are detected and altered by replacing them with transparent pixels. One technique of the filling algorithm is the “fill to border” technique which fills the detected pixels with transparent pixels. Other algorithms known in the art for performing the edge detection and replacement of pixels may also be applied.

The masking algorithm is an algorithm for hiding portions of an image and revealing other portions of the image and/or changing the opacity of the various portions of the image. Examples of the masking algorithm are layer masking, clipping masking and alpha channel masking.

The filling algorithm may be directly applied on the background of the first 2D image, such that the pixels of the background of the first 2D image are detected and replaced with transparent pixels, where the background pixels (i.e., pixels of the background) are detected and filled to the border/edge with the first object in the first 2D image. Alternatively, the filling algorithm may be applied first to the first object in the first 2D image, such that the pixels of the first object are detected and replaced with a contrasting color compared to the background pixels, preferably a primary color of a specific color mode, such as Cyan, Magenta or Yellow (CMYK: 1, 0, 0, 0; 0, 1, 0, 0; or 0, 0, 1, 0) or Red, Green or Blue (RGB: 255, 0, 0; 0, 255, 0; or 0, 0, 255), followed by filling the other pixels (i.e., the background pixels) not in said contrasting color with transparent pixels, using e.g., the “fill to border” technique. Therefore, a top mask area or layer of the first object may be obtained having said primary color, wherein the top mask layer is placed on top of any other layer in the first 2D image. Thus, the provided first 2D image (e.g., according to step 202) may be masked, using the masking algorithm, with the background having transparent pixels, resulting in a trimmed image of the first 2D image, i.e., a non-transparent area of the provided first 2D image without the background.

The method may further comprise replacing pixels of the second 2D image not overlapping the first object in the first 2D image with transparent pixels. This step is performed by applying a masking algorithm, as described herein. In examples, where the background in the first 2D image and/or the second 2D image is not transparent, the background may be in a color/pattern different from the color/pattern of the object therein (e.g., the first object in the first 2D image and/or the one or more objects in the second 2D image), such as the background and foreground having contrasting colors. It is preferred that the filling algorithm is used, as described herein, such that the pixels of the background of the first 2D image are replaced with transparent pixels.

The masking algorithm may be configured to mask part of the second 2D image not overlapping the first object in the first 2D image (i.e, overlapping the background) with the transparent pixels in the background. Therefore, the transparent pixels in the background replace or turn the pixels in the non-overlapping part of the second 2D image into transparent pixels. Thus, a new shape of the second 2D image is drawn only where both the second 2D image and the first 2D image overlap, and everything else in the second 2D image is made transparent. This can be performed by applying a mask (or a binary 2D image), where all pixels which are zero (i.e., transparent pixels) in the mask are set to zero in the second 2D image, and all the other pixels remain unchanged. Other algorithms known in the art may also be applied to trim and cut the overlay image along the edge of the first object. It is preferred that the masking algorithm is combined with the filling algorithm, such that the pixels of the background of the first 2D image are replaced with transparent pixels, as described herein, followed by replacing the non-overlapping part of the second 2D image with transparent pixels.

Embodiments of the method according to the invention will be described with reference to FIG. 4. FIG. 4 illustrates a step 408 of adjusting the second 2D image which corresponds in many aspects and/or features to the step 204.

The step 408 of adjusting the second 2D image may include step 408b of displacing pixels of the second 2D image overlapping the first object based on the displacement map and step 408c of multiplying the displaced pixels of the second 2D image with pixels of the greyscale 2D image. The step 408b of displacing pixels may be performed by a displacement mapping algorithm where a texture or height map (referred to as displacement map herein) is used to cause an effect where the actual geometric position of points over the textured surface of the first object are displaced. The step 408c of multiplying pixels may be performed by a pixel-by-pixel multiplication algorithm. Preferably, the step 408 of adjusting further includes trimming part of the second 2D image not overlapping with the first object, preferably by performing step 408a of replacing pixels of the second 2D image not overlapping the first object in the first 2D image with transparent pixels. Step 408a may include detecting pixels of the second 2D image not overlapping the first object of the first 2D image (i.e., overlapping the background of the first 2D image). It is preferred that the step 408a is performed before the steps 408b, 408c so that said steps are performed even more efficiently.

The displacement mapping algorithm modifies the geometry or coordinates of pixels of the image being displaced. The displacement mapping algorithm generates degrees embossing effects, where a darker pixel shade (i.e., higher black value) makes a low embossed effect (i.e., the coordinates of a pixel being displaced is pushed backward or down), and a lighter pixel shade (i.e., lower black value) will make a high embossed effect (i.e., the coordinates of a pixel being displaced is pushed forward or up).

The multiplication algorithm takes two input images and produces an adjusted second 2D image in which the pixel values are those of the first image, multiplied by the values of the corresponding values in the second image.

FIG. 5 illustrates example embodiments of a method according to the invention, which are not intended to limit the scope of the invention in any way. It relates to a method of overlaying 2D images, wherein the overlay method 500 comprises providing an input 501 including a first 2D image 502a including a first object, being a clothing apparel, particularly a hoodie, and a second 2D image 502b including a second object 501c, being a logo. The overlay method 500 further provides or displays an output 503 including the overlayed images.

The overlay method 500 may extract the first 502a and second 502b 2D images from the input 501 and perform the method according to the present invention, as described herein.

In this example, the first 2D image 502a, particularly the first object therein, includes an upper part 501a, being strings of the hoodie, and a lower part 501b, being the body of the hoodie, wherein the upper part 501a is on top of the lower part 501b.

The overlay method 500 detects edges of the upper part 501a and when generating a greyscale image as described herein, the overlay method 500 replaces the pixels of the upper part 501a with transparent pixels. In this example, the pixels of the overlapped part of the upper part 501a (i.e., overlapped by the second 2D image) are replaced with transparent pixels.

The output 503 in this example is provided or displayed as a single 2D image including the first 2D image 504 having the first object including the upper part 503a and further including the lower part 503b and the overlayed second object 503c thereon, wherein the upper part 503a is shown on top of the overlayed second object 503c.

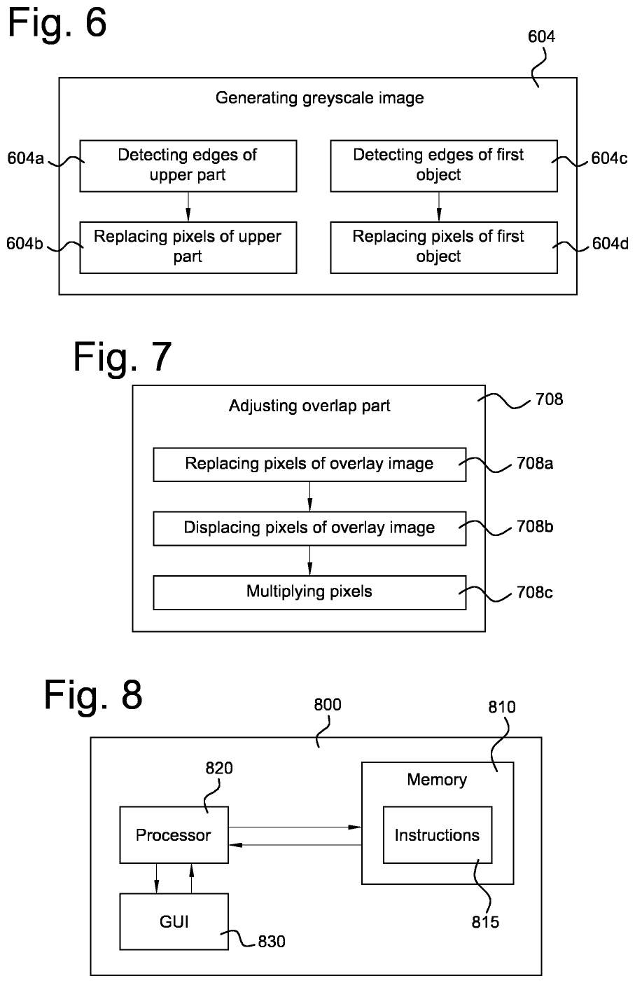

Embodiments of the method according to the invention will be described with reference to FIG. 6. FIG. 6 illustrates a step 604 of generating a greyscale 2D image which corresponds in many aspects and/or features to the step 204 and/or the step 304.

The step 604 of generating a greyscale 2D image may include step 604d (corresponding to step 304d) of generating a trimmed image by replacing pixels not part of the first object (i.e., in the of the background of the first object or first 2D image) with transparent pixels. Optionally, the step 604 of generating a greyscale 2D image comprises step 604c (corresponding to step 304c) of detecting edges of the first object. These steps can be performed by a filling algorithm, as described herein. The step 604c may not be necessary in the case where the step 202 includes detecting edges of the first object, as described herein.

Additionally or alternatively, the step 604 of generating a greyscale 2D image may include step 604a of detecting edges of an upper part of the first object, the upper part being on top of a lower part of the first object in the first 2D image. The upper part may be in a color/pattern different from the color/pattern of the lower part of the first object, such as the upper and lower parts having contrasting colors. An edge detection algorithm as described herein may be used to detect edges of the upper part of the first object. Alternatively, the step 202 of providing the first 2D image includes the step of detecting edges of the upper part of the first object, the upper part being on top of a lower part of the first object in the first 2D image. The edge detection algorithm as described herein may be used to detect edges of the upper part of the first object. Further alternatively, the first 2D image provided in step 202 includes at least two layers, an upper layer including the upper part of the first object and a lower layer including the lower part of the first object, wherein the upper layer is on top of the lower layer.

The step 604 of generating a greyscale 2D image may include step 604b of generating a trimmed image by replacing pixels of the upper part of the first object with transparent pixels. Optionally, the step 604 of generating a greyscale 2D image comprises step 604a of detecting edges of the upper part of the first object. These steps can be performed by a filling/masking algorithm, as described herein. The step 604a may not be necessary in the case where the step 202 includes the step of detecting edges of an upper part of the first object, as described herein. Preferably, the second 2D image overlaps the upper part of the first object in the first 2D image.

The filling algorithm may be directly applied on the upper part of the first 2D image, such that the pixels of the upper part of the first 2D image are detected and replaced with transparent pixels, where the pixels of the upper part are detected and filled to the border/edge with the lower part of the first 2D image. Alternatively, the filling algorithm may be applied first to the lower part of the first 2D image, such that the pixels of the lower part are detected and replaced with a contrasting color compared to the pixels of the upper part, preferably a primary color of a color mode, such as Cyan, Magenta or Yellow (CMYK: 1, 0, 0, 0; 0, 1, 0, 0; or 0, 0, 1, 0) or Red, Green or Blue (RGB: 255, 0, 0; 0, 255, 0; or 0, 0, 255), followed by filling the other pixels (i.e., the pixels of the upper part) not in said contrasting color with transparent pixels, using e.g., the “fill to border” technique.

The masking algorithm may be configured to mask the first 2D image not overlapping the first object in the first 2D image with the transparent pixels in the background. Therefore, the transparent pixels in the background replace or turn the pixels in the non-overlapping part of the second 2D image into transparent pixels. Thus, a new shape of the second 2D image is drawn only where both the second 2D image and the first 2D image overlap, and everything else in the second 2D image is made transparent. This can be performed by applying a mask (or a binary 2D image), where all pixels which are zero (i.e., transparent pixels) in the mask are set to zero in the second 2D image, and all the other pixels remain unchanged. Other algorithms known in the art may also be applied to trim and cut the overlay image along the edge of the first object. It is preferred that the masking algorithm is combined with the filling algorithm, such that the pixels of the background of the first 2D image are replaced with transparent pixels, as described herein, followed by replacing the non-overlapping part of the second 2D image with transparent pixels. Therefore, a top mask area or layer of the first object may be obtained having said primary color, wherein the top mask layer is placed on top of any other layer in the first 2D image. Thus, the provided first 2D image (e.g., according to step 202) may be masked, using the masking algorithm, with the background having transparent pixels, resulting in a trimmed image of the first 2D image, i.e., a non-transparent area of the provided first 2D image without the upper part.

The masking algorithm may be configured to mask part of the second 2D image overlapping the upper part with transparent pixels. Therefore, the transparent pixels in the upper part replace or turn the pixels in the overlapping part of the second 2D image into transparent pixels. Thus, a new shape of the second 2D image is drawn only where both the second 2D image and the lower part of the first 2D image overlap, and everything else, preferably the part of the second 2D image overlapping the upper part, is replaced with transparent pixels. This can be performed by applying a mask (or a binary 2D image), where all pixels which are zero (i.e., transparent pixels) in the mask are set to zero in the second 2D image, and all the other pixels remain unchanged. Other algorithms known in the art may also be applied to trim and cut the overlay image along the edge of the first object. It is preferred that the masking algorithm is combined with the filling algorithm, such that the pixels of the upper part of the first 2D image are replaced with transparent pixels, as described herein, followed by replacing the overlapping part of the second 2D image (i.e., overlapping the upper part) with transparent pixels.

Embodiments of the method according to the invention will be described with reference to FIG. 7. FIG. 7 illustrates a step 708 of adjusting the second 2D image which corresponds in many aspects and/or features to the step 208 and/or the step 408.

The step 708 of adjusting the second 2D image may include step 708b (corresponding to step 408b) of displacing pixels of the second 2D image overlapping the first object based on the displacement map and step 708c (corresponding to step 408c) of multiplying the displaced pixels of the second 2D image with pixels of the greyscale 2D image. Preferably, the step 708 further includes trimming part of the second 2D image overlapping with the upper part of the first object, preferably by performing step 708a of replacing pixels of the second 2D image overlapping with the upper part of the first object in the first 2D image with transparent pixels. Step 708a may include detecting pixels of the second 2D image overlapping the upper part of the first 2D image. It is preferred that the step 708a is performed before the steps 708b, 708c so that said steps are performed even more efficiently. This step is performed by applying a masking algorithm, as described herein.

The step 708 may include the step of detecting edges of one or more objects in the second 2D image and replacing pixels other than pixels of the one or more objects with transparent pixels. Thus, the one or more objects are considered to be in the foreground of the second 2D image and the transparent pixels in the background. The one or more objects may be detected by applying an edge detection algorithm and/or the pixels not part of the one or more objects (i.e., the background) are replaced with pixels by applying any filling algorithm, as described herein.

The method may comprise providing the user a graphical user interface (GUI). The user can then send instructions via the GUI relating to overlaying the images.

Embodiments of the non-transitory computer readable medium and of the apparatus according to the invention will be described with reference to FIG. 8. FIG. 8 illustrates a non-transitory computer readable medium 810 embodying or including executable instructions 815.

In embodiments, a non-transitory (or non-transient) computer readable medium containing a computer executable software which when executed on a computer system performs the method as defined herein before by the embodiments of the present disclosure. A non-transitory computer readable medium may include an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a non-transient computer readable medium may be any tangible medium that can contain, or store a program for use by or in connection with an instruction execution system, apparatus, device or module.

FIG. 8 further illustrates an apparatus 800 comprising the non-transitory computer readable medium as a memory 810 and a processor 820 coupled to the memory 810.

In embodiments according to the invention, the apparatus 800 comprises a GUI 830 configured to allow the user to provide instructions as described herein. In additional or alternative embodiments, the GUI 830 is configured to provide the user with an output of the method according to embodiments of the invention, preferably the overlayed images as described herein.

Meanwhile, the embodiments of the invention disclosed in the specification and drawings are merely to provide specific examples in order to easily explain the technical matters of the disclosure and to help understanding of the disclosure, and are not intended to limit the scope of the disclosure. That is, it will be apparent to those skilled in the art that other modified examples based on the technical idea of the disclosure may be implemented. Furthermore, it will be apparent to those skilled in the art that, in addition to the embodiments disclosed herein, other variants may be achieved on the basis of the technical idea of the invention.

In addition, the different embodiments described in the invention may be combined with each other. In addition, the scope of the invention is not limited to the examples described in the invention, and the examples are sufficiently applicable to a sufficiently opposing situation.

1. A computer-implemented method for overlaying 2D images, comprising:
providing a first 2D image and a second 2D image, wherein the first 2D image is a digital representation of a first object having a 3D surface, and wherein the second 2D image overlaps the first object in the first 2D image at a particular location;
generating a greyscale 2D image of the first 2D image, wherein the step of generating the greyscale 2D image includes generating a trimmed image by:
detecting edges of an upper part of the first object, the upper part being on top of a lower part of the first object in the first 2D image, and the upper and lower parts having contrasting colors; and
replacing pixels of the upper part of the first object with transparent pixels;
generating a displacement map of the greyscale 2D image;
adjusting the second 2D image, including:
trimming part of the second 2D image overlapping the upper part of the first object,
displacing pixels of the second 2D image overlapping the first object based on the displacement map, and
multiplying the displaced pixels of the second 2D image with pixels of the greyscale 2D image;
providing the adjusted second 2D image at the particular location on the first 2D image;
generating a final image based on the placement of the second 2D image at the particular location on the first 2D image; and
displaying the final image via a GUI, wherein the final image displays a realistic view of the second 2D image on the 3D surface without having to physically print the second 2D image on the first object.

2. The computer-implemented method of claim 1, wherein the step of providing the first 2D image includes: detecting edges of the first object in the first 2D image, the first object being in the foreground of the first 2D image, and the first object and the background of the first 2D image having contrasting colors.

3. The computer-implemented method of claim 2, wherein the step of generating the greyscale 2D image includes generating the trimmed image by replacing pixels not part of the first object with transparent pixels.

4. The computer-implemented method of claim 1, wherein the step of adjusting the second 2D image further includes: trimming a part of the second 2D image not overlapping the first object in the first 2D image by replacing pixels of the second 2D image not overlapping the first object in the first 2D image with transparent pixels.

5. The computer-implemented method of claim 1, wherein the step of generating the greyscale 2D image includes generating the trimmed image by:
replacing pixels of the lower part of the first object with pixels having a primary color of a specific color mode.

6. The computer-implemented method of claim 1, wherein the step of generating the greyscale 2D image includes generating the trimmed image by:
detecting pixels of the upper part being overlapped by the second 2D image; and
replacing the overlapped pixels of the upper part of the first object with transparent pixels.

7. The computer-implemented method of claim 1, wherein the first 2D image includes an upper layer including the upper part of the first object and a lower layer including the lower part of the first object,
wherein the step of generating the greyscale 2D image includes generating the trimmed image by replacing pixels of the upper layer or removing the upper layer.

8. The computer-implemented method of claim 1, wherein the step of trimming the second 2D image includes:
detecting pixels of the second 2D image overlapping the upper part of the first 2D image; and
replacing the overlapped pixels of the second 2D image with transparent pixels.

9. The computer-implemented method of claim 1, wherein the second 2D image includes one or more layers, each layer including an object in the foreground of the layer and transparent pixels in the background of the layer.

10. The computer-implemented method of claim 1, wherein the step of adjusting the second 2D image includes:
detecting edges of one or more objects in the foreground of the second 2D image; and
replacing pixels of the background in the second 2D image with transparent pixels.

11. The computer-implemented method of claim 1, wherein the method further comprises:
increasing dimensions of the second 2D image to be equal to dimensions of the first 2D image by adding transparent pixels.

12. A non-transitory computer readable medium embodying computer executable instructions which when executed by a computer cause the computer to facilitate a method of:
providing a first 2D image and a second 2D image, wherein the first 2D image is a digital representation of a first object having a 3D surface, and wherein the second 2D image overlaps the first object in the first 2D image at a particular location;
generating a greyscale 2D image of the first 2D image, wherein the step of generating the greyscale 2D image includes generating a trimmed image by:
detecting edges of an upper part of the first object, the upper part being on top of a lower part of the first object in the first 2D image, and the upper and lower parts having contrasting colors; and
replacing pixels of the upper part of the first object with transparent pixels;
generating a displacement map of the greyscale 2D image;
adjusting the second 2D image, including:
trimming part of the second 2D image overlapping the upper part of the first object,
displacing pixels of the second 2D image overlapping the first object based on the displacement map, and
multiplying the displaced pixels of the second 2D image with pixels of the greyscale 2D image;
providing the adjusted second 2D image at the particular location on the first 2D image;
generating a final image based on the placement of the second 2D image at the particular location on the first 2D image; and
displaying the final image via a GUI, wherein the final image displays a realistic view of the second 2D image on the 3D surface without having to physically print the second 2D image on the first object.

13. The non-transitory computer readable medium of claim 12, wherein the step of providing the first 2D image includes:
detecting edges of the first object in the first 2D image the first object being in the foreground of the first 2D image, and the first object and the background of the first 2D image having contrasting colors,
wherein the step of generating the greyscale 2D image includes generating the trimmed image by replacing pixels not part of the first object with transparent pixels.

14. The non-transitory computer readable medium of claim 12, wherein the step of adjusting the second 2D image further includes: trimming a part of the second 2D image not overlapping the first object in the first 2D image by replacing pixels of the second 2D image not overlapping the first object in the first 2D image with transparent pixels.

15. The non-transitory computer readable medium of claim 12, wherein the step of trimming the second 2D image includes:
detecting pixels of the second 2D image overlapping the upper part of the first 2D image; and
replacing the overlapped pixels of the second 2D image with transparent pixels.

16. An apparatus comprising a memory embodying computer executable instructions and at least one processor, coupled to the memory, and operative by the computer executable instructions to facilitate a method of:
providing a first 2D image and a second 2D image, wherein the first 2D image is a digital representation of a first object having a 3D surface, and wherein the second 2D image overlaps the first object in the first 2D image at a particular location;
generating a greyscale 2D image of the first 2D image, particular location;
generating a greyscale 2D image of the first 2D image, wherein the step of generating the greyscale 2D image includes generating a trimmed image by:
detecting edges of an upper part of the first object, the upper part being on top of a lower part of the first object in the first 2D image, and the upper and lower parts having contrasting colors; and
replacing pixels of the upper part of the first object with transparent pixels;
generating a displacement map of the greyscale 2D image;
adjusting the second 2D image, including:
trimming part of the second 2D image overlapping the upper part of the first object,
displacing pixels of the second 2D image overlapping the first object based on the displacement map, and
multiplying the displaced pixels of the second 2D image with pixels of the greyscale 2D image;
providing the adjusted second 2D image at the particular location on the first 2D image;
generating a final image based on the placement of the second 2D image at the particular location on the first 2D image; and
displaying the final image via a GUI, wherein the final image displays a realistic view of the second 2D image on the 3D surface without having to physically print the second 2D image on the first object.

17. The apparatus of claim 16, wherein the step of providing the first 2D image includes:
detecting edges of the first object in the first 2D image, the first object being in the foreground of the first 2D image, and the first object and the background of the first 2D image having contrasting colors, and
wherein the step of generating the greyscale 2D image includes generating the trimmed image by replacing pixels not part of the first object with transparent pixels.

18. The apparatus of claim 16, wherein the step of adjusting the second 2D image further includes: trimming a part of the second 2D image not overlapping the first object in the first 2D image by replacing pixels of the second 2D image not overlapping the first object in the first 2D image with transparent pixels.

19. The apparatus of claim 16, wherein the step of generating the greyscale 2D image includes generating the trimmed image by:
replacing pixels of the lower part of the first object with pixels having a primary color of a specific color mode.

20. The apparatus of claim 16, wherein the step of trimming the second 2D image includes:
detecting pixels of the second 2D image overlapping the upper part of the first 2D image; and
replacing the overlapped pixels of the second 2D image with transparent pixels.
